(19) United States
(12) Patent Application Publication
(10) Pub. No.: US 2002/0081150 A1
(43) Pub. Date: Jun. 27, 2002

(54) Screw compressor

(76) Inventors: Pasqaule Patrizio Pellicano, Imola (IT); Loredana Predieri, Zola Predosa (IT)

Correspondence Address: QUARLES & BRADY LLP, 411 E. WISCONSIN AVENUE, SUITE 2040, MILWAUKEE, WI, 53202-4497, US

(21) Appl. No.: 09/993,209

(22) Filed: Nov. 16, 2001

(30) Foreign Application Priority Data
Nov. 17, 2000 (IT) B02000A000668

(51) Int. Cl. F16D 1/00

(52) U.S. Cl. 403/334; 403/359.6

(57) ABSTRACT

A screw compressor has an electric motor having a first output shaft; and two intermeshing rotors, one of which has a second output shaft substantially coaxial with the first output shaft; the first and the second output shaft being connected directly by a conical coupling.

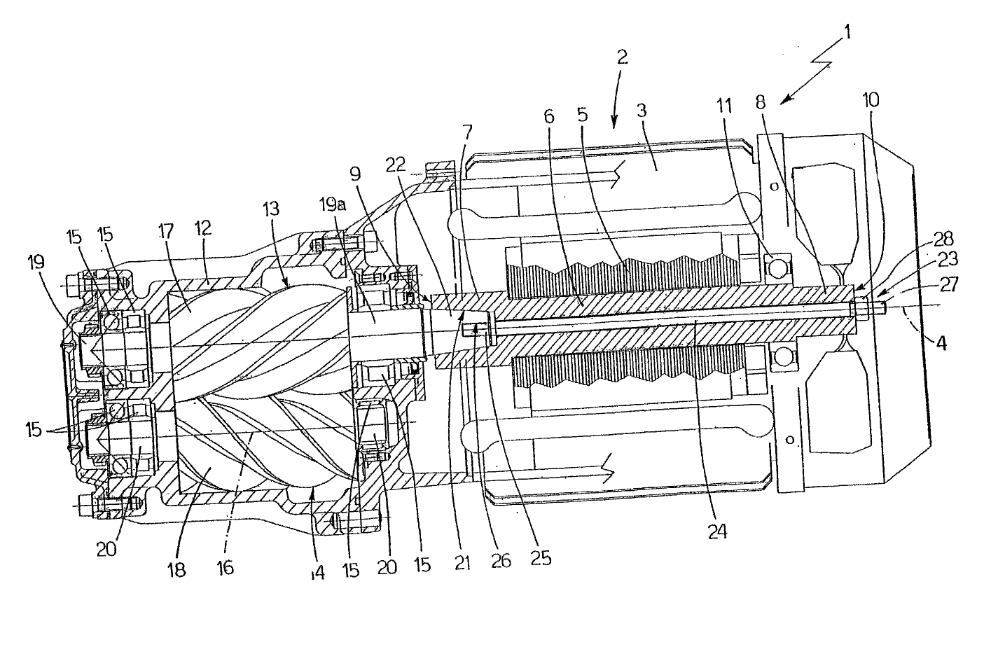

### BACKGROUND OF THE INVENTION

The present invention relates to a screw compressor.

More specifically, the present invention relates to a screw compressor of the type comprising an electric motor with a first output shaft; two intermeshing rotors, one of which has a second output shaft substantially coaxial with and facing the first shaft; and connecting means for connecting the first and second shaft in angularly fixed manner.

Normally, said connecting means comprise an elastic joint, in turn comprising two half-joints interference-fitted respectively to the first and second shaft; and a rubber ring interposed between the two half-joints.

The compressor also comprises two bearings between the rotors and the electric motor, for respectively supporting the first and second shaft in rotary manner. More specifically, the bearing supporting the first shaft is housed inside a tubular housing interposed between a first tubular casing housing the two rotors, and a second tubular casing housing the electric motor.

As a result, known screw compressors of the above type are relatively long, and are fairly expensive owing to the presence of the elastic joint, the two bearings supporting the first and second shaft, and the tubular housing.

Moreover, the two half-joints must be expanded thermally to engage the first and second shaft in axially sliding manner, so that fitting and removing the half-joints to and from the shafts are relatively painstaking jobs.

### SUMMARY OF THE INVENTION

It is an object of the present invention to provide a screw compressor designed to eliminate the aforementioned drawbacks.

According to the present invention, there is provided a screw compressor comprising an electric motor having a first output shaft; two intermeshing rotors, a first of said rotors having a second output shaft substantially coaxial with said first shaft; and connecting means for connecting said first and said second shaft in angularly fixed manner; and characterized in that said connecting means comprise conical connecting means for connecting said first and said second shaft directly.

### BRIEF DESCRIPTION OF THE DRAWING

A non-limiting embodiment of the present invention will be described by way of example with reference to the accompanying drawing showing an axial section.

### DETAILED DESCRIPTION OF THE INVENTION

Number 1 in the accompanying drawing indicates as a whole a screw compressor comprising an electric motor 2 having a tubular outer casing 3, which has a substantially horizontal longitudinal axis 4 and houses a rotor 5 fitted to a tubular output shaft 6 substantially coaxial with axis 4.

Shaft 6 has two end portions 7, 8 located at opposite ends of rotor 5 and defined axially by respective flat surfaces 9, 10 substantially crosswise to axis 4, and is mounted to rotate about axis 4 with respect to casing 3 and via the interposition of a rolling bearing 11 at portion 8.

Compressor 1 also comprises a tubular outer casing 12 connected directly to casing 3 and housing two rotors 13, 14, which, via the interposition of rolling bearings 15, are rotated by motor 2 with respect to casing 12, one about axis 4, and the other about an axis 16 substantially parallel to axis 4.

Each rotor 13, 14 comprises a central portion 17, 18, which is coaxial with respective axis 4, 16, has a symmetrically helical outer contour, and meshes with portion 18, 17 of the other rotor 14, 13 to compress a fluid inside casing 12 as the two rotors 13, 14 are counter-rotated by motor 2.

Each rotor 13, 14 also comprises a pair of shanks 19, 20, which are preferably, though not necessarily, formed in one piece with relative portion 17, 18, are located at opposite ends of relative portion 17, 18, and are coaxial with relative axis 4, 16.

In a variation not shown, shanks 19, 20 of each rotor 13, 14 define the end portions of a relative output shaft to which relative portion 17, 18 is fitted.

Portion 7 has a substantially truncated-cone-shaped seat 21, which is coaxial with axis 4, opens outwards at surface 9, and receives and retains a substantially truncated-cone-shaped end 22 of one of shanks 19 (hereinafter indicated 19a) of rotor 13. In a variation not shown, seat 21 may receive and retain a substantially truncated-cone-shaped end of one of shanks 20 of rotor 14.

Shank 19a is locked axially and angularly by friction inside seat 21 by means of a locking device 23. Device 23 comprises a substantially cylindrical rod 24, which is housed inside shaft 6, is connected in rotary and axially sliding manner to shaft 6, and has a threaded first end 25 engaging a corresponding threaded dead hole 26 formed in shank 19a and substantially coaxial with axis 4, and a threaded second end 27 extending outwards of shaft 6. Device 23 also comprises a lock nut 28 fitted to end 27 and for moving rod 24 axially to lock shank 19a axially and angularly by friction inside seat 21.

Operation of compressor 1 is easily deducible from the foregoing description with no further explanation required.

Compressor 1 has several advantages, the main ones of which derive from the fact that:

bearing 15 supporting shank 19a of rotor 13 also serves to support portion 7 of shaft 6 of electric motor 2;

connecting rotor 13 directly to shaft 6 provides for a relatively compact compressor 1, measured parallel to axis 4, and for simplifying assembly of compressor 1; and

compressor 1 can be disassembled relatively easily by releasing locking device 23 from tubular shaft 6, and releasing shank 19a from seat 21 by means of a straightforward threaded extractor, which is inserted along shaft 6 into contact with end 22, and is screwed inside a threaded end portion (not shown) of portion 8 to release shank 19a from seat 21.

1) A screw compressor comprising an electric motor (2) having a first output shaft (6); two intermeshing rotors (13, 14), a first (13) of said rotors (13, 14) having a second output shaft (19) substantially coaxial with said first shaft (6); and connecting means (19a, 21) for connecting said first (6) and said second (19) shaft in angularly fixed manner; and characterized in that said connecting means (21, 22, 23) comprise conical connecting means (21, 22) for connecting said first (6) and said second (19) shaft directly.

2) A compressor as claimed in claim 1, wherein said first shaft (6) comprises a substantially truncated-cone-shaped seat (21), and said second shaft (19) comprises a substantially truncated-cone-shaped end (22) engaging said seat (21); said conical connecting means (21, 22) comprising said seat (21) and said end (22).

3) A compressor as claimed in claim 2, wherein said connecting means (21, 22, 23) also comprise locking means (23) for locking said end (22) axially inside said seat (21) in such a manner as to connect said first (6) and said second (19) shaft frictionally.

4) A compressor as claimed in claim 3, wherein said first shaft (6) is a tubular shaft; said locking means (23) comprising a rod (24) housed in axially sliding manner inside said tubular shaft; and further connecting means (25, 26) being provided to fit said rod (24) removably to said second shaft (19).

5) A compressor as claimed in claim 4, wherein said further connecting means (25, 26) are screw connecting means.

6) A compressor as claimed in claim 4, wherein said locking means (23) comprise actuating means (28) for moving said rod (24) from a release position to a lock position locking said second shaft (19) to said first shaft (6).

7) A compressor as claimed in claim 6, wherein said rod (24) has a threaded further end (27) extending outwards of said first shaft (6); said actuating means (28) comprising a nut (28) fitted to said further end (27).

8) A compressor as claimed in claim 1, and also comprising a single bearing (15) interposed between said first rotor (13) and said electric motor (2), and for supporting both said first shaft (6) and said second shaft (19).

9) A compressor as claimed in claim 1, wherein said electric motor (2) comprises a first tubular outer casing (3); the compressor also comprising a second tubular outer casing (12) housing said rotors (13, 14) and connected directly to said first tubular outer casing (3).
